(19) United States
(12) Patent Application Publication
(10) Pub. No.: US 2011/0062199 A1
(43) Pub. Date: Mar. 17, 2011

(54) Handlebar attachment for bicycle

(76) Inventor: Ying Hui Liu, Changhua (TW)

(21) Appl. No.: 12/586,112

(22) Filed: Sep. 17, 2009

(51) Int. Cl. B62J 7/06; B62J 9/00

(52) U.S. Cl. 224/420; 74/551.8

(57) ABSTRACT

A handlebar attachment includes a handlebar attached to an attaching device, and a carrier having a housing member for receiving various objects and having an opening formed in a rear portion of the housing member for engaging with the attaching device and for attaching the housing member of the carrier to the attaching device and the handlebar, and the carrier includes one or more fastening devices attached to the housing member for engaging with the handlebar and for solidly attaching the housing member to the attaching device and the handlebar. The carrier includes a flexible flap extended into the opening of the housing member for engaging with the attaching device.

### BACKGROUND OF THE INVENTION

1. Field of the Invention

The present invention relates to a handlebar attachment for bicycle, and more particularly to a handlebar attachment including a housing for receiving various objects and for easily and quickly attaching to a handlebar of the bicycle, and allowing the various objects to be easily obtained by the user when the user is riding the bicycle.

2. Description of the Prior Art

Typical handlebars for bicycles comprise a horizontal tube attached to top of a vertical tube or steering tube, and a handlebar attached to the horizontal tube for being grasped or held by the user, particularly when the user is riding the bicycle.

For example, U.S. Pat. No. 5,515,744 to Liao, U.S. Pat. No. 5,588,336 to Chou, U.S. Pat. No. 6,186,027 to Nielsen, and U.S. Pat. No. 6,374,697 to Brandl et al. disclose four of the typical handlebars for bicycles each also comprising a horizontal stem attached to top of a vertical tube or steering tube, and a handlebar attached to the horizontal stem for being grasped or held by the user.

However, the vertical tube or steering tube is designed and provided for attaching or supporting the horizontal stem and may not be used or provided for attaching or supporting the other objects. Normally, a carrying case or bag is required to be provided and attached to the rear carrier rack of the bicycle for receiving various objects. However, the objects received in the carrying case or bag are disposed on the rear carrier rack of the bicycle and may not be easily obtained by the user, particularly when the user is riding the bicycle.

The present invention has arisen to mitigate and/or obviate the afore-described disadvantages of the conventional handlebar attachments for the bicycles.

### SUMMARY OF THE INVENTION

The primary objective of the present invention is to provide a handlebar attachment including a housing for receiving various objects and for easily and quickly attaching to a handlebar of the bicycle, and allowing the various objects to be easily obtained by the user when the user is riding the bicycle.

In accordance with one aspect of the invention, there is provided a handlebar attachment comprising an attaching device, a handlebar attached to the attaching device, and a carrier including a housing member for receiving various objects and having an opening formed in a rear portion thereof for receiving and engaging with the attaching device and for easily and quickly attaching the housing member of the carrier to the attaching device and the handlebar, and the carrier includes at least one fastening device or strap attached to the housing member for engaging with the handlebar and for further easily and quickly and solidly attaching or securing the housing member to the attaching device and the handlebar and allowing the various objects received in the housing member of the carrier and/or in the auxiliary bags to be supported in front of the user, and to be easily and quickly obtained by the user when the user is riding the bicycle.

The fastening device includes a fastening strap for engaging with the handlebar, and the fastening device includes at least one buckle attached to the fastening strap for solidly securing the fastening device to the handlebar. The carrier includes at least one auxiliary bag attached to the housing member for receiving the other objects.

The carrier includes a flexible flap extended into the opening of the housing member for engaging with the attaching device and for further anchoring or securing the carrier to the attaching device and/or the handlebar.

The carrier includes at least one fastening ring attached to the housing member, and a carrying strap attached to the housing member with the fastening ring for allowing the housing member of the carrier to be easily or suitably carried by the user when the housing member of the carrier is disengaged from the attaching device and/or the handlebar.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a handlebar attachment in accordance with the present invention;

FIG. 2 is a partial perspective view of the handlebar attachment for the bicycle, illustrating the operation of the handlebar attachment for the bicycle; and

FIG. 3 is a perspective view illustrating the operation of the handlebar attachment for the bicycle.

### DETAILED DESCRIPTION OF THE PREFERRED EMBODIMENT

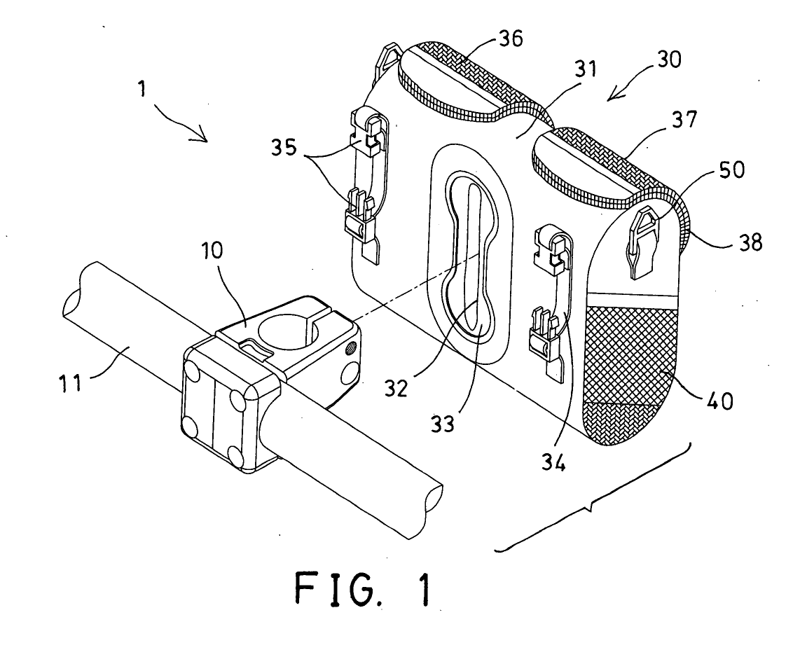

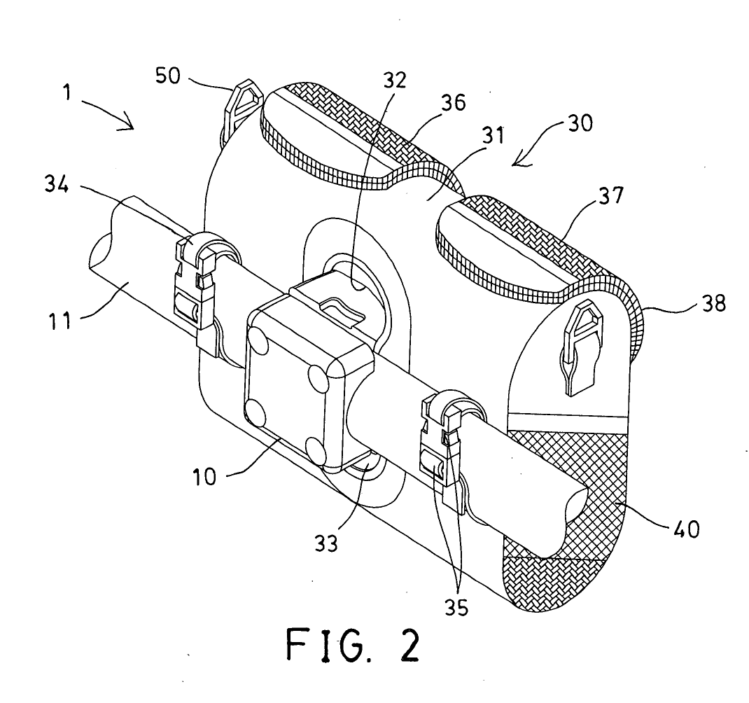

Referring to the drawings, and initially to FIGS. 1 and 2, a handlebar attachment 1 in accordance with the present invention comprises a horizontal tube or attaching device 10 to be attached to or disposed on top of a vertical tube or steering tube (not shown) of a bicycle, and a handlebar 11 attached to the horizontal tube or attaching device 10 for being grasped or held by the user. The above-described attaching structure of the handlebar 11 to the horizontal tube or attaching device 10 is typical and will not be described in further details.

The handlebar attachment 1 further comprises a carrier 30 including a bag or housing member 31 for receiving various objects therein and having an opening 32 formed in the rear portion thereof for receiving or engaging with the attaching device 10 (FIG. 2) and for easily and quickly attaching the housing member 31 of the carrier 30 to the attaching device 10 and/or the handlebar 11, and the carrier 30 includes a flexible film or membrane or flap 33 extended into the opening 32 for engaging with the attaching device 10 and for anchoring or securing the carrier 30 to the attaching device 10 and/or the handlebar 11.

The carrier 30 further includes one or more (such as two) fastening straps or devices 34 mounted or attached to the two side portions of the rear portion of the housing member 31 of the carrier 30 for engaging with the handlebar 11, and for further quickly and solidly attaching or securing the housing member 31 of the carrier 30 to the attaching device 10 and/or the handlebar 11 with buckles 35. The carrier 30 may include one or more compartments or covers 36, 37 openably attached to the housing member 31 with a securing device 38, such as zippers 38, and may include one or more auxiliary bags 40 detachably attached to the housing member 31 with the other securing device 38, such as zippers 38.

In operation, as shown in FIGS. 1 and 2, the housing member 31 of the carrier 30 may be easily and quickly attached to the attaching device 10 and/or the handlebar 11 by engaging the attaching device 10 into the opening 32 of the housing member 31, and/or by engaging the fastening straps or devices 34 with the handlebar 11, and the housing member 31 of the carrier 30 will be supported in front of the user such that the various objects received in the housing member 31 of the carrier 30 and/or in the auxiliary bags 40 may be easily and quickly obtained by the user when the user is riding the bicycle.

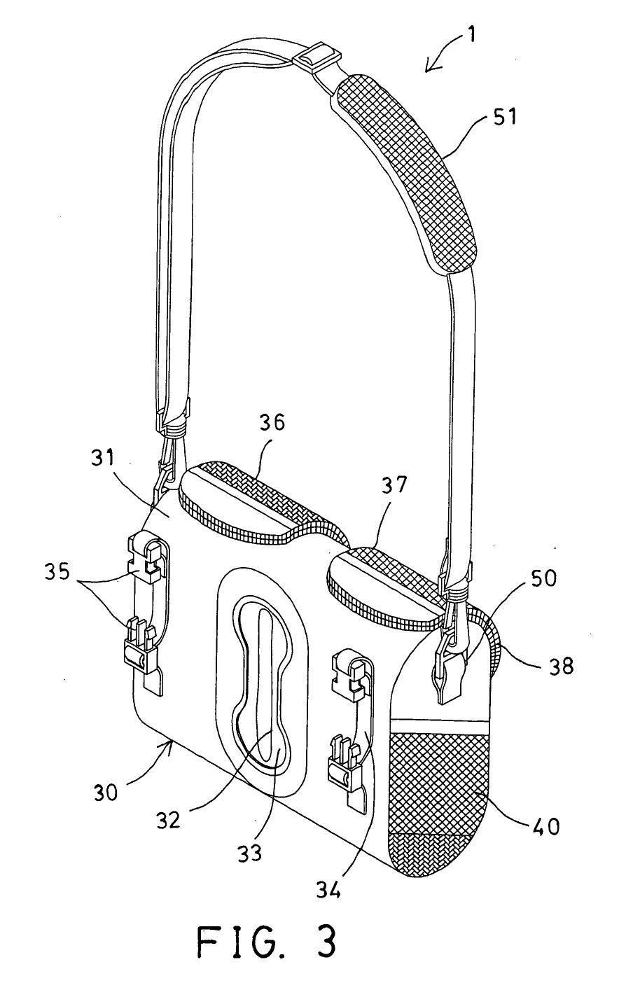

The carrier 30 may further include one or more (such as two) fastening rings 50 mounted or attached to the two side portions of the housing member 31 of the carrier 30 for engaging with a carrying strap 51 (FIG. 3) and for allowing the housing member 31 of the carrier 30 to be easily or suitably carried by the user when the housing member 31 of the carrier 30 is disengaged from the attaching device 10 and/or the handlebar 11. It is to be noted that the housing member 31 of the carrier 30 may be supported in front of the user such that the various objects received in the housing member 31 of the carrier 30 and/or in the auxiliary bags 40 may be easily and quickly obtained by the user when the user is riding the bicycle.

Accordingly, the handlebar attachment in accordance with the present invention includes a housing for receiving various objects and for easily and quickly attaching to a handlebar of the bicycle, and allowing the various objects to be easily obtained by the user when the user is riding the bicycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A handlebar attachment comprising:
an attaching device,
a handlebar attached to said attaching device, and
a carrier including a housing member having an opening formed in a rear portion thereof for receiving and engaging with said attaching device and for attaching said housing member of said carrier to said attaching device and said handlebar, and said carrier including at least one fastening device attached to said housing member for engaging with said handlebar and for attaching said housing member to said attaching device and said handlebar.

2. The handlebar attachment as claimed in claim 1, wherein said at least one fastening device includes a strap for engaging with said handlebar.

3. The handlebar attachment as claimed in claim 2, wherein said at least one fastening device includes at least one buckle attached to said strap for securing said at least one fastening device to said handlebar.

4. The handlebar attachment as claimed in claim 1, wherein said carrier includes a flexible flap extended into said opening of said housing member for engaging with said attaching device.

5. The handlebar attachment as claimed in claim 1, wherein said carrier includes at least one fastening ring attached to said housing member, and a carrying strap attached to said housing member with said at least one fastening ring.

6. The handlebar attachment as claimed in claim 1, wherein said carrier includes at least one auxiliary bag.
